(19) United States
(12) Patent Application Publication
(10) Pub. No.: US 2010/0043235 A1
(43) Pub. Date: Feb. 25, 2010

(54) UTILITY KNIFE WITH EXTENDED TRAVEL CARRIAGE

(76) Inventor: Wen Hao, Industry, CA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/195,958

(22) Filed: Aug. 21, 2008

(51) Int. Cl. B26B 1/08

(52) U.S. Cl. 30/162

(57) ABSTRACT

A utility knife has a handle generally defining a handle axis and a remote end provided with an opening. A carriage is slidably mounted within the handle for selective movements through the opening between a retracted position in which the carriage is substantially fully received within the handle and a fully extended position in which the carriage is fully extended through the opening to increase the effective length of said handle by a distance Δl. A blade mounted on the carriage shares the movements of the carriage and has an operative portion that can fully penetrate a work to be cut when the handle axis is inclined at an angle α relative to a surface of the work. A finger of a user most proximate to the work surface is positionable a distance h above the work surface during normal use of the utility knife, Δl and α being selected so that the distance Δl is generally greater that 1.0 inch and the angle α is equal to at least 35°.

### BACKGROUND OF THE INVENTION

1. Field of the Invention

This invention and generally relates to hand tools, and, more specifically, to a utility knife with an extended travel carriage.

2. Description of the Prior Art

Utility knives have long been used for cutting generally thin works such as the cardboard, fabrics, sheets of plastic materials and thin strips of wood. Such knives, however, have generally been large and a bulky. Numerous designs have been proposed to render utility knives generally thinner and shorter along in the axial length of the handles to make the units portable and more comfortable to hold. However, a problem with utility knives that have short handles is that when only a small portion of the blade is extended from the handle and that portion of the blade is fully inserted through or penetrates the work to be cut at least the lowermost finger of the user, most proximate to the upper surface of the work to be cut, can be positioned very close to the material being cut. If the utility knife handle is not held at the proper angle or the normal or recommended angle of inclination is decreased the lowermost finger of the user can contact the surface being cut and the finger can be injured as it is moved over the upper surface of the material, particularly if in the upper surface of the material is not smooth but somewhat abrasive.

To overcome the above-mentioned problem some utility knife designs have used shorter handles in conjunction with an internal blade-carrying carriage that can be fully retracted within the handle so that both of the carriage and the cutting portion of the blade are fully contained within the handle when not in use. When the unit is to be used, the carriage is extended beyond the remote end of the handle to effectively increase the overall length of the handle so that when the utility knife handle is held at a designated angle relative to the work the lowermost finger is elevated above the work surface in an effect to avoid injury to the finger(s).

A utility knife of the general type under discussion is described in the U.S. patent application Ser. No. 12/114,234, assigned to the assignee of the subject application, which application is incorporated by reference as if fully set forth herein.

Referring to FIG. 1, a prior art utility knife is illustrated in which a handle 12 defines a handle axis A. The handle has a leading or remote end, 12x that forms a positive angle α with the axis A so that the upper edge or surface 12y of the handle 12 is shorter than the lower edge or surface 12z. The utility knife 12 has a lateral slot S through which an actuating button B can be moved forwardly and rearwardly to move a carriage 14 to an extended or retracted position, respectively. In FIG. 1, the carriage 14 is shown in its extended position with a blade 16 removably mounted thereon for penetration through a work 18. Initially, the position of the button B on the side of the handle requires a two hand operation for moving the button B and the carriage. Additionally, because the button B is located at a position intermediate the upper and lower surfaces or edges 12y and 12z the extent of travel of the button B and, therefore, the carriage 16, is limited. Also, because of such limited travel, the closed or retracted length of the overall tool is 4.3125 inches while the open or extended length is 5.6875 inches. The change in length, therefore, or incremental length Δl, is 1.375 inches, or the percentage of incremental length is approximately 31.88%. With such a handle and a limited incremental length change when the blade is extended, the height “h” of the lowermost finger F above the upper surface 18a is approximately 0.97 in. when the angle α is selected to be approximately 45° during normal use.

For purposes of this application the height of the finger F above the work surface 18a is the distance between the work surface 18a and approximately the center or central axis A_{f} of the finger.

### SUMMARY OF THE INVENTION

Accordingly, it is an object to the invention to provide a utility knife that does not have the disadvantages of comparable prior art utility knives.

It is another object of the invention to provide a utility knife that is simple in construction and economical to manufacture.

It is still another object of the invention to provide a utility knife that is convenient to use.

It is yet another object of the invention to provide a utility knife that is ergonomically configured and comfortable to use.

It is further object of the invention to provide a utility knife of the general type under discussion that is mounted for extended travel externally of the handle when moved to its operative extended position to position the fingers of the user at a safer distance from the work being cut to prevent injury to the user.

It is still a further object of the invention to provide a utility knife, as in the previous object, in which an actuating button for extending and retracting the carriage is arranged on the handle for maximum sliding movements to optimize the extent of the travel of the carriage when it is extended outside the handle.

It is yet a further object of the invention to provide a utility knife, as in previous object, that positions the fingers of the user at a safe distance above the work surface even when the utility knife reasonably deviates from the optimum angular position during normal use.

In order to achieve the above objects, as well as others that will become apparent hereafter, a utility knife in accordance with the invention has a generally short handle defining a handle axis and a remote end provided with an opening. A carriage is mounted within the handle for movements through the opening between a retracted position in which the carriage is substantially fully received within the handle and a fully extended position in which the carriage is fully extended through the opening to increase the effective length of the handle by an incremental length Δl. A blade is mounted on the carriage for sharing the movements of the carriage and has an operative portion that can fully penetrate a work to be cut when the handle axis is inclined at an angle α relative to a work surface, a finger of a user most proximate to the work surface being positioned the distance “h” above the work surface during the normal use of the utility knife. The quantities Δl and α are selected so that the distance “h” is generally greater than 1.0 inch.

### BRIEF DESCRIPTION OF THE DRAWINGS

The above and other objects, features and advantages of the present invention will be better understood from the following specification when read in conjunction with the accompanying drawings.

FIG. 1 is a side elevational view of a prior art utility knife, indicating the proximity of the lowermost or pointing index finger to the upper surface of the work to be cut during normal use; and

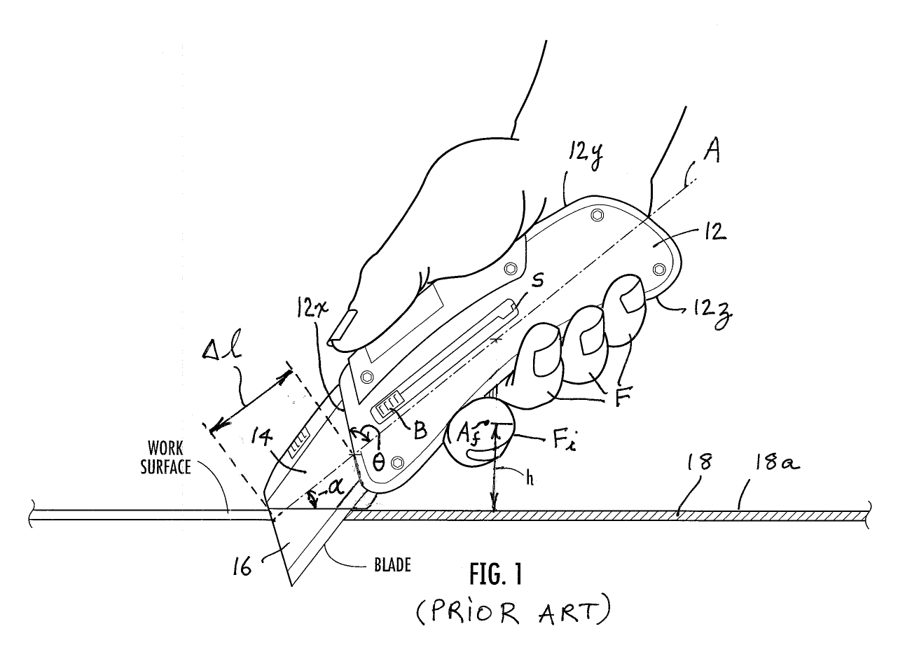

FIG. 2 is a side elevational view similar to FIG. 1 of a utility knife in accordance with the present invention in which the carriage has an extended travel to effectively lift or raise the lowermost or pointing or index finger above the surface of the work to avoid scraping or other injury to the finger.

### DETAILED DESCRIPTION OF THE DRAWINGS

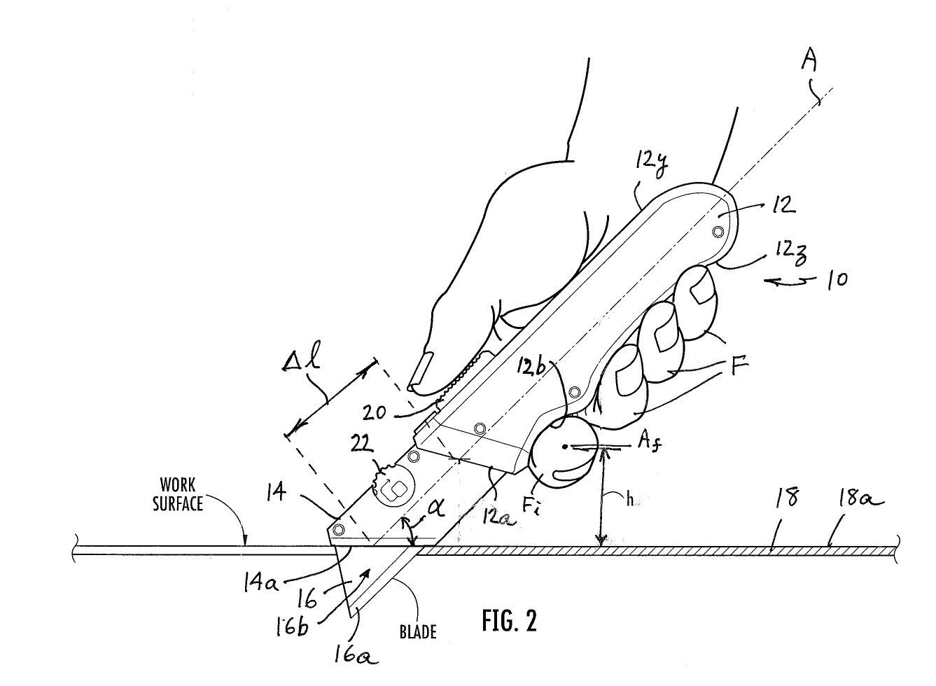

Referring now specifically to FIG. 2, a utility knife in accordance with the invention is generally designated by the reference numeral 10.

The utility knife 10 has a handle 12 typically formed of two similar clam shells that are secured to one another in any conventional way to create an internal cavity. The handle 12 has an axis A that extends along the longitudinal length direction of the handle 12.

Mounted within the handle 12 is a carriage 14 that removably supports a blade 16 that has a cutting edge 16a as shown. The carriage 14 extends along the axis A and has an inclined remote end 14a that generally forms an angle α with the axis A. The inclined remote end 14a is generally parallel to a remote edge 12a of the handle. The blade 16 is removably mounted to the carriage 14 to expose a generally triangular operative portion 16b of the blade that can be inserted into the work 18 to penetrate through the work for cutting purposes. The remote edge 14a of the carriage serves as a guide to a user to position the handle 12 at a desired angle α by maintaining the edge 14a generally coextensive with the upper surface 18a the work 18 that faces the handle 12.

A button or actuating element 20 is arranged along the upper edge or surface 12y of the handle and is connected or linked to the carriage 14 so that the carriage shares movement of the button 20 as the button is actuated by the thumb of a user for single-handled operation. The connection is through a slot (not shown) in the upper edge or surface 12y of the handle 12, in a manner disclosed in co-pending U.S. patent application Ser. No. 12/114,234, which is incorporated by reference as if fully set forth herein.

The lower surface or the edge on the handle 12 is preferably provided with a series of indentations 12b that serve as recesses for partially receiving the fingers F. The indentations 12b not only make the handle more ergonomic and more comfortable to hold but also serve to partially receive portions of the fingers to effectively elevate them further above the work surface 18a.

The blade 16 can be removed from the carriage by rotating the release element or disk 22 with the thumb of the user, as more fully described in the aforementioned co-pending application.

It will be appreciated that with an extended travel carriage 14 the increased length Δl causes the lowermost or index finger Fᵢ to be raised further above the work 18 when the handle is held at or close to the desired angle α, providing increased comfort and safety to the user by preventing the index finger of the user from touching or scraping the surface 18a.

An example of a utility knife according to the present invention has an overall length of 1.5 inches when the carriage is in a fully retracted position and 6.1875 inches in an extended position. The incremental change in length Δl, therefore, is 1.6875 inches, for a percentage increase in length of approximately 37.5 percent. In accordance with the invention the quantity Δl is equal to a greater than 1.4 inches and preferably greater than or equal 1.5 inches. In accordance with a presently preferred embodiment Δl is within the range of 1.6 to 1.7 inches. The angle α is preferably selected to be a equal to or greater than 35° and, preferably the angle α is selected to be within the range of 40-50°. In accordance with the presently preferred embodiment illustrated in FIG. 2 the angle α is approximately equal to 45°.

As indicated, the handle has upper and lower surfaces or edges 12y, 12z, the actuating button or member 20 being coupled to the carriage 14 and movable between the proximate and remote positions of the handle so that the carriage moves between the retracted and extended positions.

As suggested, the lower surface of the handle 12 is preferably provided with a series of recesses or indentations 12b arranged to at least partially receive the fingers of the user to effectively increase the distance “h” of the lower most or index finger Fᵢ above the upper surface of the work to be cut. As shown in FIG. 2, the lowermost recess indentation closest to the remote end of the handle is deeper than the remaining recesses along the lower surface to further elevate or raise that finger Fᵢ and make the handle 12 more ergonomic and comfortable to the user.

A guide edge 14a of the carriage is arranged at the angle α with the guide edge positioned coextensively with a work surface of the work to maximize penetration while assist the user in maintaining the handle at the proper and safe angle α.

While the invention has been shown and described in connection with a preferred form of an embodiment it will be understood that modifications may be made without the departure from the scope or spirit of the invention.

1. Utility knife having a handle generally defining a handle axis and a remote end provided with an opening; a carriage slidably mounted within said handle for movements through said opening between a retracted position in which said carriage is substantially fully received within said handle and a fully extended position in which said carriage is fully extended through said opening to increase the effective length of said handle by a distance Δl; a blade mounted on said carriage for sharing the movements of said carriage and having an operative portion that can fully penetrate a work to be cut when said handle axis is inclined at an angle α relative to a surface of the work; a finger of a user most proximate to the work surface positioned a distance h above the work surface during normal use of the utility knife, Δl and a being selected so that the distance Δl is generally greater than 1.0 inch.

2. Utility knife as claimed in claim 1, wherein Δl≧1.4 inches.

3. Utility knife as claimed in claim 2, wherein Δl≧1.5 inches.

4. Utility knife as claimed in claim 2, wherein Δl≧is whether the range if 1.6 and 1.7 inches.

5. Utility knife as claimed in claim 1, wherein α is selected to be equal to ≧35°.

6. Utility knife as claimed in claim 5, wherein α is selected to be equal to ≧48-50°.

7. Utility knife as claimed in claim 6, wherein α≈45°.

8. Utility knife as claimed in claim 1, wherein said handle has upper and lower surfaces, a button coupled to said carriage and actuatable by the thumb of a user being arranged at said upper surface and movable between approximate and remote positions to move said carriage between said retracted and extended positions.

9. Utility knife as claimed in claim 8, wherein said lower surfaces provided with a series of recesses arranged to at least partially receive the finger of the user to effectively increase the distance h.

10. Utility knife as claimed in claim 9, wherein said lower-most recess closest to said remote end of said handle is the deeper than the remaining recesses along said lower surface.

11. Utility knife as claimed in claim 1, wherein said remote end of said handle has a guide edge for properly positioning said handle at said angle α when said guide edge is positioned coextensively with the work surface of the work.

12. Utility knife as claimed in claim 11, wherein said guide edge is inclined at said angle α relative to said handle axis.

13. Utility knife as claimed in claim 12, wherein said angle α is selected between angle 40-50°.

14. Utility knife as claimed in claim 13, wherein said angle α≈45°.
